(19) United States
(12) Patent Application Publication
(10) Pub. No.: US 2019/0094577 A1
(43) Pub. Date: Mar. 28, 2019

(54) LIQUID CRYSTAL DISPLAYS AND LIQUID CRYSTAL DEVICES

(71) Applicant: Shenzhen China Star Optoelectronics Technology Co. Ltd, Shenzhen, Guangdong (CN)

(72) Inventor: Yong FAN, Shenzhen, Guangdong (CN)

(73) Assignee: Shenzhen China Star Optoelectronics Technology Co., Ltd., Shenzhen, Guangdong (CN)

(21) Appl. No.: 15/536,900

(22) PCT Filed: May 25, 2017
(86) PCT No.: PCT/CN2017/085847

§ 371 Date: Jun. 16, 2017

(30) Foreign Application Priority Data
May 12, 2017 (CN) 201710333998.0

(51) Int. Cl. G02F 1/1334; G02F 1/1335; G02F 1/1333

(52) U.S. Cl. CPC G02F 1/1334; G02F 2203/02; G02F 1/133377; G02F 1/133514

(57) ABSTRACT

The present disclosure relates to a liquid crystal panel and a liquid crystal device (LCD). The liquid crystal panel includes a first substrate, a second substrate opposite to the first substrate, and at least one polymer dispersed liquid crystal (PDLC) being configured between the first substrate and the second substrate, and a plurality of reflective walls. The first substrate is spaced apart from the second substrate. The reflective walls are arranged within the PDLC in sequence. The reflective walls are spaced apart from each other along a direction parallel to the liquid crystal panel. The reflective walls are configured to reflect light beams irradiating on the reflective walls such that an optical amount of the light beams before reflection being greater than the optical amount of the light beams after the reflection.

### BACKGROUND OF THE INVENTION

### 1. Field of the Invention

The present disclosure relates to display technology, and more particularly to a liquid crystal panel and a liquid crystal device (LCD).

### 2. Discussion of the Related Art

Polymer Dispersed Liquid Crystal (PDLC) is also known as liquid crystal dimming film. The PDLC is prepared by mixing the low molecular liquid crystal and by conducting polymerization reaction under certain conditions and evenly dispersing the micron-level liquid crystal particles in the polymer network so as to obtain the material having electro-optical response characteristics by the dielectric anisotropy of the liquid crystal molecules. PDLC mainly works between the scattering state and the transparent state. Specifically, when the driving voltage is not applied, the PDLC cannot form a regular electric field, the optical axis of the liquid crystal particles is disordered, and the incident light beams are scattered. As such, PDLC is opaque or translucent. When being applied with the driving voltage, the optical axis of the liquid crystal particles orient along the direction of the electric field. The incident light beams are not scattered, and the PDLC is in the translucent state. PDLC has an optical switching characteristic when driven by the applied electric field, and the transparency degree of the PDLC increases as the driving voltage increases. When compared with the liquid crystal panel of vertical alignment (VA) or In-Plane Switching (IPS) modes, the PDLC liquid crystal panel owns good electro-optical characteristics. Not only the polarizer may be excluded, the cost and the power consumption may be saved.

However, as the contrast of the PDLC liquid crystal panel is not good enough, currently, the contrast of the PDLC liquid crystal panel may be enhanced by increasing the thickness of the liquid crystal layer. Such solution may greatly increase the driving voltage, and thus the driving cost and the power consumption are increased.

### SUMMARY

The present disclosure relates to a liquid crystal panel and a LCD for enhancing contrast of displayed images without increasing the cost and the power consumption.

In one aspect, a liquid crystal panel includes: a color filter (CF) substrate, an array substrate opposite to the CF substrate, and at least one polymer dispersed liquid crystal (PDLC) is configured between the CF substrate and the array substrate, a plurality of photo spacers (PSs) and a plurality of reflective walls, the CF substrate is spaced apart from the array substrate, the reflective walls are arranged within the PDLC in sequence, the reflective walls are spaced apart from each other along a direction parallel to the liquid crystal panel, each of the reflective walls is configured with a plurality of dots, and each of the reflective walls is perpendicular to the CF substrate and the array substrate, the reflective walls are configured to reflect light beams irradiating on the reflective walls such that an optical amount of the light beams before reflection is greater than the optical amount of the light beams after the reflection, the PSs are arranged along the direction parallel to the liquid crystal panel in sequence, the PSs are spaced apart from each other, and a number of the reflective walls between any two adjacent PSs are the same.

In another aspect, a liquid crystal panel includes: a first substrate, a second substrate opposite to the first substrate, and at least one polymer dispersed liquid crystal (PDLC) is configured between the first substrate and the second substrate, and a plurality of reflective walls, the first substrate is spaced apart from the second substrate, the reflective walls are arranged within the PDLC in sequence, the reflective walls are spaced apart from each other along a direction parallel to the liquid crystal panel, the reflective walls are configured to reflect light beams irradiating on the reflective walls such that an optical amount of the light beams before reflection is greater than the optical amount of the light beams after the reflection.

In another aspect, a liquid crystal device (LCD) includes: a backlight module and a liquid crystal panel provided in a light emission direction of the backlight module, the liquid crystal panel includes: a CF substrate, an array substrate opposite to the first substrate, and at least one polymer dispersed liquid crystal (PDLC) is configured between the CF substrate and the array substrate, and a plurality of reflective walls, the CF substrate is spaced apart from the array substrate, the reflective walls are arranged within the PDLC in sequence, the reflective walls are spaced apart from each other along a direction parallel to the liquid crystal panel, the reflective walls are configured to reflect light beams irradiating on the reflective walls such that an optical amount of the light beams before reflection is greater than the optical amount of the light beams after the reflection.

In view of above, by configuring the wall structure having a low reflective rate, within the PLDC, the contrast of the displayed image may be enhanced. Compared to the conventional technology, the thickness of the liquid crystal cell of the claimed invention may remain the same. In addition, it is not needed to greatly increase the driving voltage, and thus the driving cost and the power consumption may remain the same.

### BRIEF DESCRIPTION OF THE DRAWINGS

FIG. 1 is a cross section view of the liquid crystal panel in accordance with one embodiment of the present disclosure.

FIG. 2 is a cross section view of the liquid crystal panel in accordance with another embodiment of the present disclosure.

FIG. 3 is a cross section view of the LCD in accordance with one embodiment of the present disclosure.

### DETAILED DESCRIPTION OF THE EMBODIMENTS

Embodiments of the invention will now be described more fully hereinafter with reference to the accompanying drawings, in which embodiments of the invention are shown.

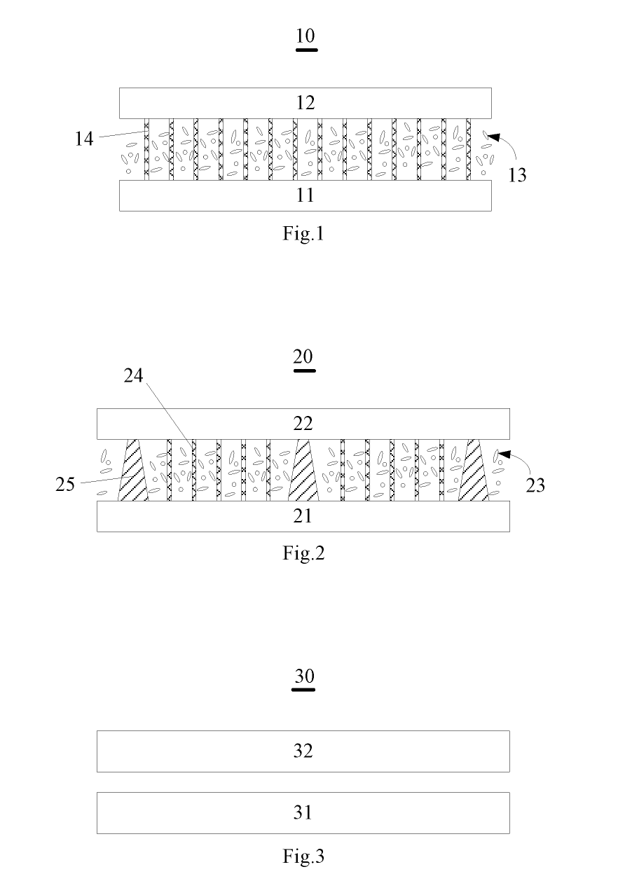

FIG. 1 shows a liquid crystal panel in accordance with one embodiment of the present disclosure. The flexible display panel 10 includes a thin film transistor (TFT) array substrate 11, a color filter (CF) substrate 12, at least one Polymer Dispersed Liquid Crystal (PLDC) 13, and a plurality of reflective walls 14, wherein the TFT array substrate 11 is opposite to the CF substrate 12.

The PLDC 13 is arranged within a liquid crystal cell formed between the CF substrate 11 and the second end portion 12.

Along a horizontal direction of the liquid crystal panel 10, as shown, the reflective walls 14 are arranged within the PLDC 13 in sequence. In real scenario, the reflective walls 14 directly abut against the TFT array substrate 11 and the CF substrate 12, and the reflective walls 14 are perpendicular to the TFT array substrate 11 and the CF substrate 12. For instance, one end of the reflective walls 14 may abut against a common electrode located on the outmost side of the CF substrate 12, and the other end of the reflective walls 14 may abut against a protection layer on the outmost side of the TFT array substrate 11. In another example, with respect to the CF substrate 12 without being configured with the common electrode, one end of the reflective walls 14 may abut against the color filters located on the outmost side of the CF substrate 12, and the other end of the reflective walls 14 may abut against the protection layer located on the outmost side of the 11 may abut against the protection layer located on the outmost side of the TFT array substrate 11.

When a driving voltage is applied to the liquid crystal panel 10, an optical axis of the liquid crystal particles within the PLDC 13 is arranged along a direction of the electric field. Incident light beams perpendicular to the liquid crystal panel 10 may not be scattered by the liquid crystal particles, and the PLDC 13 is transparent. When the driving voltage is not applied to the liquid crystal panel 10, the PLDC 13 cannot form a regular electric field. The optical axis of the liquid crystal particles may be in a disorder state, and the incident light beams may be scattered by the liquid crystal particles. At this moment, the PLDC 13 may be opaque or translucent, i.e., in a scattering state. When the scattered light beams irradiate on the reflective walls 14, an optical amount after the reflection is smaller than the optical amount before the reflection due to the reflective walls 14, which results in that the optical amount of the PLDC 13 has been greatly decreased. As such, the brightness differences of the display image in the scatting state and in the transparent state have been greatly increased so as to enhance the contrast of the displayed images.

It can be seen that by configuring the wall structure 14 having a low reflective rate, such as below 40%, within the PLDC 13, the contrast of the displayed image may be enhanced. Compared to the conventional technology, the thickness of the liquid crystal cell of the claimed invention may remain the same. In addition, it is not needed to greatly increase the driving voltage, and thus the driving cost and the power consumption may remain the same.

When the PLDC 13 is in the scattering state, the scattered light beams irradiating on the reflective walls 14 may be non-uniform, which may form optical spots on the reflective walls 14. To prevent the display performance from being affected, a plurality of dots may be configured on the reflective walls 14, which may further reduce the reflective rate of the reflective walls 14, including the reflective rate for the areas having the optical spots. It can be understood that a gatekeeper having a low reflective rate has been configured within the PLDC 13.

In another example, an outer surface of the reflective walls 14 may be configured with an absorbent layer for absorbing the scattered light beams irradiating on the reflective walls 14. As such, the optical amount after the reflection is smaller than the optical amount before the reflection. This further reduces the reflective rate of the reflective walls 14 so as to enhance the contrast of the displayed image.

The surface of the reflective walls 14 may be configured with the absorbent layer for absorbing the scattered light beams irradiating on the reflective walls 14. This further reduces the reflective rate of the reflective walls 14 so as to enhance the contrast of the displayed image.

In addition, to prevent the liquid crystal particles within the PLDC 13 from being affected by the electricity carried by the reflective walls 14, the reflective walls 14 may be formed by insulation materials.

FIG. 2 shows the liquid crystal panel in accordance with another embodiment. The liquid crystal panel 20 includes an array substrate 21, a CF substrate 22 opposite to the array substrate 21, the PDLC 23 between the two substrates, a plurality of reflective walls 24, and a plurality of photo spacers (PSs) 25.

The PDLC 23 is arranged between the liquid crystal cell between the TFT array substrate 11 and the CF substrate 12.

The PSs 25 are arranged along a direction parallel to the direction of the liquid crystal panel 20 in sequence, and the PSs 25 are spaced apart from each other. The PSs 25 are configured such that the thickness of the liquid crystal cell is uniform.

The reflective walls 24 are configured within the PDLC 23, and are spaced apart from each other along the direction parallel to the direction of the liquid crystal panel 20. In one example, the number of the reflective walls 24 between two adjacent PSs 25 may be the same. In addition, with respect to the reflective walls 24 arranged between two adjacent PSs 25, the distance between the PSs 25 to the reflective walls 24 may be the same. That is, the PSs 25 are configured within the PDLC 23 in an uniform manner.

When a driving voltage is applied to the liquid crystal panel 20, an optical axis of the liquid crystal particles within the PLDC 23 is arranged along a direction of the electric field. Incident light beams perpendicular to the liquid crystal panel 20 may not be scattered by the liquid crystal particles, and the PLDC 23 is transparent.

When the driving voltage is not applied to the liquid crystal panel 20, the PLDC 23 cannot form a regular electric field. The optical axis of the liquid crystal particles may be in a disorder state, and the incident light beams may be scattered by the liquid crystal particles.

At this moment, the PLDC 23 may be in the scattering state. When the scattered light beams irradiate on the reflective walls 24, an optical amount after the reflection is smaller than the optical amount before the reflection due to the reflective walls 24, which results in that the optical amount of the PLDC 23 has been greatly decreased. As such, the brightness differences of the display image in the scatting state and in the transparent state have been greatly increased so as to enhance the contrast of the displayed images.

It can be seen that by configuring the wall structure 24 having a low reflective rate, within the PLDC 23, the contrast of the displayed image may be enhanced. Compared to the conventional technology, the thickness of the liquid crystal cell of the claimed invention may remain the same. In addition, it is not needed to greatly increase the driving voltage, and thus the driving cost and the power consumption may remain the same.

The present disclosure also relates to a LCD. As shown in FIG. 3, the LCD 30 includes a backlight module 31 and a liquid crystal panel 32 provided in a light emission direction of the backlight module 31. The backlight module 31 includes a collimated backlight source for emitting incident light beams perpendicular to the liquid crystal panel 32. The liquid crystal panel 32 may be the liquid crystal panel 10 in FIG. 1, or the liquid crystal panel 20 in FIG. 2. Thus, the LCD 30 includes the technical features of the liquid crystal panel 10 or the liquid crystal panel 20 as described above.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal panel, comprising:
a color filter (CF) substrate, an array substrate opposite to the CF substrate, and at least one polymer dispersed liquid crystal (PDLC) being configured between the CF substrate and the array substrate, a plurality of photo spacers (PSs) and a plurality of reflective walls, the CF substrate being spaced apart from the array substrate, the reflective walls being arranged within the PDLC in sequence, the reflective walls being spaced apart from each other along a direction parallel to the liquid crystal panel, each of the reflective walls being configured with a plurality of dots, and each of the reflective walls being perpendicular to the CF substrate and the array substrate, the reflective walls being configured to reflect light beams irradiating on the reflective walls such that an optical amount of the light beams before reflection being greater than the optical amount of the light beams after the reflection, the PSs being arranged along the direction parallel to the liquid crystal panel in sequence, the PSs being spaced apart from each other, and a number of the reflective walls between any two adjacent PSs being the same.

2. The liquid crystal panel as claimed in claim 1, wherein the reflective walls are of sheet-shaped structures being made by insulation materials.

3. The liquid crystal panel as claimed in claim 1, wherein an absorbent layer is configured on an outer surface of the reflective walls.

4. The liquid crystal panel as claimed in claim 1, wherein a distance between two adjacent reflective walls configured between two adjacent PSs is the same.

5. A liquid crystal panel, comprising:
a first substrate, a second substrate opposite to the first substrate, and at least one polymer dispersed liquid crystal (PDLC) being configured between the first substrate and the second substrate, and a plurality of reflective walls, the first substrate being spaced apart from the second substrate, the reflective walls being arranged within the PDLC in sequence, the reflective walls being spaced apart from each other along a direction parallel to the liquid crystal panel, the reflective walls being configured to reflect light beams irradiating on the reflective walls such that an optical amount of the light beams before reflection being greater than the optical amount of the light beams after the reflection.

6. The liquid crystal panel as claimed in claim 5, wherein each of the reflective walls being perpendicular to the first substrate and the second substrate.

7. The liquid crystal panel as claimed in claim 5, wherein each of the reflective walls being configured with a plurality of dots.

8. The liquid crystal panel as claimed in claim 5, wherein the reflective walls are of sheet-shaped structures being made by insulation materials.

9. The liquid crystal panel as claimed in claim 5, wherein an absorbent layer is configured on an outer surface of the reflective walls.

10. The liquid crystal panel as claimed in claim 5, wherein the liquid crystal panel further comprises a plurality of PSs arranged between the first substrate and the second substrate, the PSs being arranged along the direction parallel to the liquid crystal panel in sequence, the PSs being spaced apart from each other, and a number of the reflective walls between any two adjacent PSs being the same.

11. The liquid crystal panel as claimed in claim 10, wherein a distance between two adjacent reflective walls configured between two adjacent PSs is the same.

12. The liquid crystal panel as claimed in claim 5, wherein the first substrate and the second substrate are respective a color filter (CF) substrate and an array substrate.

13. A liquid crystal device (LCD), comprising:
a backlight module and a liquid crystal panel provided in a light emission direction of the backlight module, the liquid crystal panel comprising:
a CF substrate, an array substrate opposite to the first substrate, and at least one polymer dispersed liquid crystal (PDLC) being configured between the CF substrate and the array substrate, and a plurality of reflective walls, the CF substrate being spaced apart from the array substrate, the reflective walls being arranged within the PDLC in sequence, the reflective walls being spaced apart from each other along a direction parallel to the liquid crystal panel, the reflective walls being configured to reflect light beams irradiating on the reflective walls such that an optical amount of the light beams before reflection being greater than the optical amount of the light beams after the reflection.

14. The LCD as claimed in claim 13, wherein the backlight module comprises a collimated backlight source.

15. The LCD as claimed in claim 13, wherein each of the reflective walls being perpendicular to the first substrate and the second substrate.

16. The LCD as claimed in claim 13, wherein each of the reflective walls being configured with a plurality of dots.

17. The LCD as claimed in claim 13, wherein the reflective walls are of sheet-shaped structures being made by insulation materials.

18. The LCD as claimed in claim 13, wherein an absorbent layer is configured on an outer surface of the reflective walls.

19. The LCD as claimed in claim 13, wherein the liquid crystal panel further comprises a plurality of PSs arranged between the first substrate and the second substrate, the PSs being arranged along the direction parallel to the liquid crystal panel in sequence, the PSs being spaced apart from each other, and a number of the reflective walls between any two adjacent PSs being the same.

20. The LCD as claimed in claim 19, wherein a distance between two adjacent reflective walls configured between two adjacent PSs is the same.
